(19) United States
(12) Patent Application Publication
(10) Pub. No.: US 2012/0239413 A1
(43) Pub. Date: Sep. 20, 2012

(54) Sending Healthcare Information Securely

(75) Inventors: Alok Mathur, Alpharetta, GA (US); Ashish Shah, Chicago, IL (US); Carol Lynn Owen, Sandy, UT (US); Robert Emmitt Connelly, III, Roswell, GA (US); Andreas Achille Piccolo, Gainesville, GA (US); Saurabh Mathur, Cumming, GA (US); Steven Matthew Tripp, Draper, UT (US)

(73) Assignee: Medicity, Inc., Salt Lake City, UT (US)

(21) Appl. No.: 13/398,791

(22) Filed: Feb. 16, 2012

Related U.S. Application Data
(60) Provisional application No. 61/443,549, filed on Feb. 16, 2011.

(51) Int. Cl. G06Q 50/22

(52) U.S. Cl. 705/2

(57) ABSTRACT

A health information services provider (HISP) application includes a controller, a transaction engine, a data encryption engine, an authentication engine, a user interface engine and a registration engine. The controller manages the core functions and transmission to the different components of the HISP application. The transaction engine routes messages and requests for joining a grid. The data encryption engine encrypts or decrypts messages. The authentication engine verifies messages. The user interface engine generates a user interface for exchanging healthcare information between providers. The registration engine registers providers to exchange healthcare information with other providers.

### CROSS-REFERENCE TO RELATED APPLICATIONS

The present application claims priority under 35 USC §119(e) to U.S. Provisional Application No. 61/443,549, entitled “System and Method for Managing Healthcare Information Using the Direct Project Specifications Including Processing Information between Remotely Located Healthcare Entities,” filed Feb. 16, 2011, the entirety of each of which is hereby incorporated by reference.

### BACKGROUND

1. Field of the Invention

The invention relates to managing healthcare information in a distributed system. In particular, the invention relates to sending secure messages that include healthcare information in a distributed system.

2. Description of the Related Art

The exchange of electronic healthcare information over networks is increasing as people in healthcare practices convert their paper files to electronic files and connect their practices to the network. The electronic healthcare information is exchanged between medical offices and other physicians, local hospitals and clinics, local and national labs, imaging centers, insurance payers, local pharmacies, public health and government agencies and patients. This type of collaboration requires numerous healthcare transactions with many different people and organizations. These transactions include ordering and scheduling tests, obtaining results, referring and consulting on patients with other providers, obtaining authorization and filing claims with insurance payers and prescribing and filling medications. Physicians and their staff are frequently on the phone, at the fax machine and on the Internet performing collaborative exchanges. Some of the cost associated with these exchanges would be reduced if more of the communications were performed electronically.

Previous attempts to overcome these problems suffer from deficiencies. For example, some physicians have created electronic medical records (EMRs), however, the physicians typically maintain an internal system and if they do exchange information it is only with hospitals, payers, labs and pharmacies. Thus, the physicians are missing an opportunity for a larger exchange of information.

Health information exchanges (HIEs) are appearing in many communities, however, they lack widespread acceptance and their focus is on creating comprehensive, patient-centric records and not on enhancing clinical workflow for physician practices.

Other solutions suffer from deficiencies that prevent them from being adopted by physicians. For example, most software is insufficient or too immature to meet the broad range of collaborative needs of a physician's practice. In addition, the costs of adopting the technology, both for the licensing and the expense of re-engineering the practice, are often considered too great. Lastly, the existing systems fail to match the established workflow that the physicians and staff are accustomed to performing. As a result, the existing system must be restructured, which requires manual intervention by the staff to complete the process.

### SUMMARY OF THE INVENTION

The technology described in the specification overcomes the deficiencies and limitations of the prior art at least in part by providing a system and method for managing healthcare information. A health information service provider (HISP) application registers new users and manages secure exchange of healthcare information between users. The HISP application receives a message and determines endpoints of a message from a provider directory based on a destination of the message. The HISP application determines an encryption method for applying to the message based on capabilities of the endpoint.

In one embodiment, the HISP application includes a controller, a transaction engine, a data encryption engine, an authentication engine, a user interface engine, a registration engine and a provider directory. The controller manages the core functions and transmission to the different components of the HISP application. The transaction engine routes messages and requests for joining a grid. The data encryption engine generates certificate for new, creates and manages a white list of accepted users, creates and manages a revocation list for deactivated users and encrypts or decrypts messages. The authentication engine verifies messages. The user interface engine generates a user interface for registering users, displaying information about transaction and messaging trends for a system administrator and exchanging healthcare information between providers. The registration engine registers users to exchange healthcare information with other providers. The provider directory receives requests for email addresses based on keywords and retrieves email addresses of users within the system that match the keywords according to location or terms within the email address.

The HISP application advantageously provides a way for users to easily get connected to the grid, receive healthcare information and send secured messages.

### BRIEF DESCRIPTION OF THE DRAWINGS

The invention is illustrated by way of example, and not by way of limitation in the figures of the accompanying drawings in which like reference numerals are used to refer to similar elements.

FIG. 1a is a high-level block diagram illustrating a system for managing healthcare information according to one embodiment.

FIG. 1b is a block diagram illustrating a system for managing healthcare information according to another embodiment.

FIG. 2 is a block diagram of a health information services provider application according to one embodiment.

FIG. 3A is a graphic representation of a user interface for registering a provider to exchange healthcare information with other users according to one embodiment.

FIG. 3B is a graphic representation of a user interface for associating a provider with a health domain address according to one embodiment.

FIG. 3C is a graphic representation of a user interface for selecting a recipient for a message according to one embodiment.

FIG. 4 is a graphic representation of a user interface for generating a message for secure transfer from one provider to another provider according to one embodiment.

FIG. 5 is a graphic representation of a user interface for viewing and sending messages according to one embodiment.

FIG. 6 is a flow diagram of a method for enrolling a user and connecting the user to the grid according to one embodiment.

FIG. 7A is a flow diagram of a method for securely exchanging healthcare information between providers according to one embodiment.

FIG. 7B is a flow diagram of a method for securely exchanging healthcare information between providers according to one embodiment.

### DETAILED DESCRIPTION OF THE PREFERRED EMBODIMENTS

A system and method for securely exchanging healthcare information are described below. In the following description, for purposes of explanation, numerous specific details are set forth in order to provide a thorough understanding of the invention. It will be apparent, however, to one skilled in the art that the technology described in the various example embodiments can be practiced without these specific details. In other instances, structures and devices are shown in block diagram form in order to avoid obscuring the invention.

Reference in the invention to “one embodiment,” “an embodiment” or “an example embodiment” means that a particular feature, structure, or characteristic described in connection with the embodiment is included in at least one embodiment of the description. The appearances of the phrase “in one embodiment” in various places in the invention are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiment of the invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the invention is not described with reference to any particular programming language. It will be appreciated that a variety of programming languages may be used to implement the teachings of the invention as described herein.

### System Overview

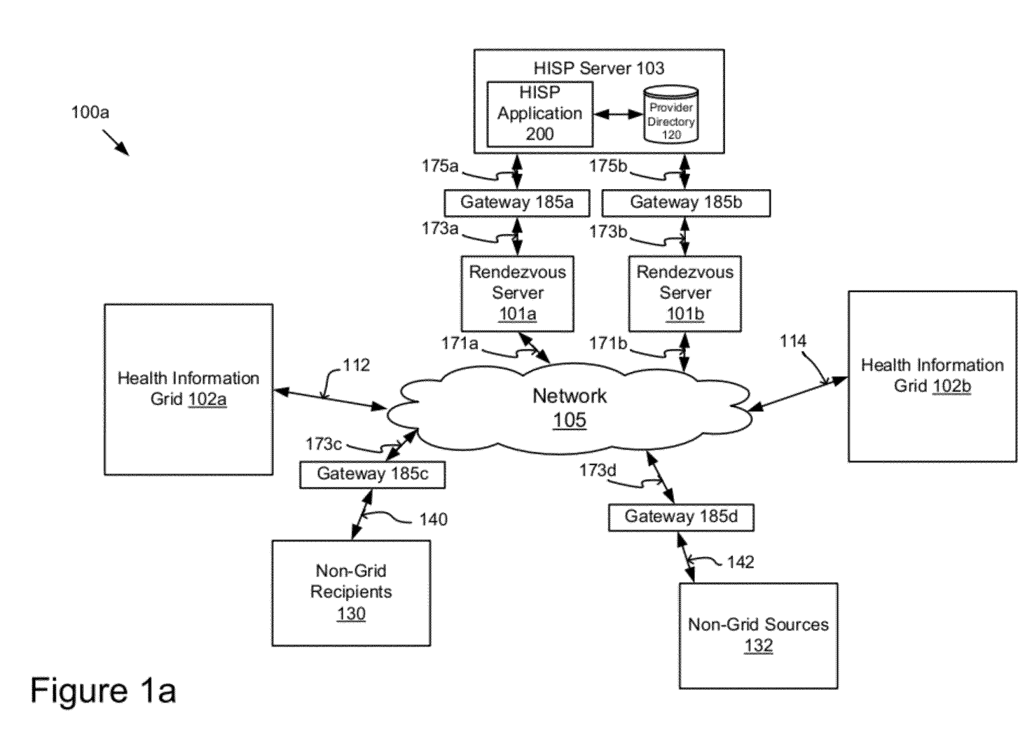

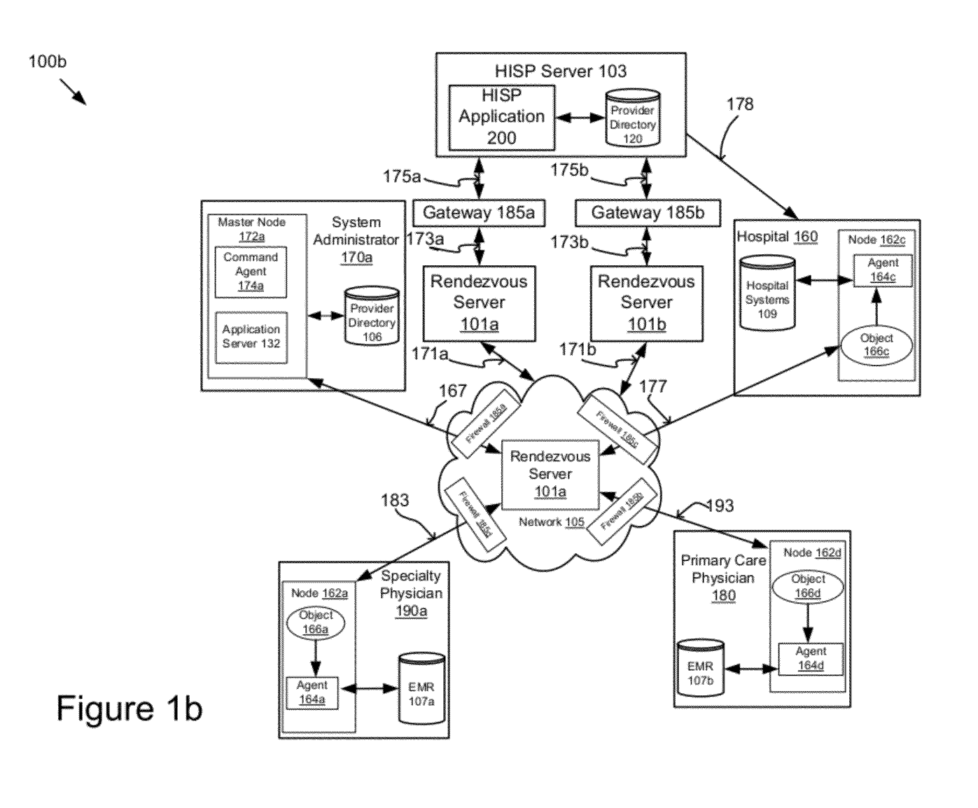

FIG. 1a illustrates a block diagram of a system 100a for managing healthcare information that is transmitted between two different grids according to one embodiment of the invention. In FIG. 1a and the remaining figures, a letter after a reference number, such as “102a” is a reference to the element having that particular reference number. A reference number in the text without a following letter, such as “102,” is a general reference to any or all instances of the element bearing that reference number. In the illustrated embodiment, these entities are communicatively coupled via a network 105.

The illustrated description of a system 100a for managing healthcare information includes health information grids 102a and 102b, non-grid recipients 130, non-grid sources 132, rendezvous servers 101a and 101b, gateways 185a and 185b and HISP server 103. In the illustrated embodiment, these entities are communicatively coupled via a network 105. While FIG. 1a illustrates two health information grids 102a and 102b, the description applies to any system architecture having one or more health information grids 102. A health information grid 102 is an information grid that distributes and synchronizes information between computers running node software. For example, a health information grid 102a includes servers, computers, databases, etc. that are used to manage a hospital or something larger such as a university healthcare system that includes a hospital and individual physicians. Health information grid 102a is coupled to the network 105 via signal line 112 and health information grid 102b is coupled to the network via signal line 114.

Each healthcare information grid 102 is associated with a rendezvous server 101 for managing asynchronous communication of information between the computers running node software and a gateway 185 that acts as a network adapter. The healthcare information grid 102 is described in greater detail in U.S. Pat. No. 7,653,634 and U.S. Pat. No. 7,953,699, each of which is herein incorporated by reference. The rendezvous server 101 transmits communications to a gateway 185 that are forwarded to a health information service provider (HISP) server 103 that manages communication of information between different healthcare information grids 102, non-grid recipients 130 and non-grid sources 132. The gateway 185 also picks up information from the health information service provider (HISP) server 103 and routes it to the appropriate healthcare information grid 102 via the rendezvous server 101.

So, for example, a user at health information grid 102a wants to send a message to a user at health information grid 102b. The health information grid 102a transmits a message to rendezvous server 101a, which is coupled to the network 105 via signal line 171a. The rendezvous server 101a transmits the message to the gateway 185a via signal line 173a. The gateway 185a forwards the message to the HISP server 103 via signal line 175a. Other HISPs (not shown) are possible and in the event that a user at one grid wants to communicate with a user at another HISP, the HISP server 103 transmits the message to the other HISP.

The HISP server 103 includes a HISP application 200 that determines where to route the message. In one embodiment, the HISP application 200 retrieves information for transmitting the message from the provider directory 120. The HISP application 200 transmits the message to gateway 185b via signal line 175b. The gateway 185b transmits the message to rendezvous server 101b via signal line 173b. The rendezvous server 101b routes the message to the health information grid 102b. Other HISPs (not shown) are possible and in the event that a user at one grid wants to communicate with a user at another HISP, the HISP server 103 transmits the message to the other HISP.

Non-grid recipients 130 and non-grid sources 132 are practices, providers or organizations that are not participants in either health information grid 102a or health information grid 102b and that exchange information with providers in health information grid 102a or health information grid 102b. The non-grid recipients 130 receive information from a user on the grid that is transmitted from rendezvous server 101 via signal line 173c and then picked up and delivered to the non-grid recipients via signal line 140 from a gateway 185c. Similarly, the non-grid sources 132 transmit information to a gateway 185d via signal line 142 that encrypts the data with the proper PKI keys so that it can be received by the rendezvous server 101 via signal line 173d.

The network 105 is a conventional type, wired or wireless, and may have any number of configurations such as a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In yet another embodiment, the network 105 may be a peer-to-peer network. The network 105 may also be coupled to or includes portions of a telecommunications network for sending data in a variety of different communication protocols. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, email, etc.

FIG. 1b illustrates a block diagram of a system 100b for managing healthcare information in a single grid according to another embodiment of the invention. The illustrated description of a system 100b for managing healthcare information includes a rendezvous server 101a, a system administrator 170a, the HISP server 103, a hospital 160, a specialty physician 190a and a primary care physician 180. The hospital 160, specialty physician 190a and primary care physician 180 and rendezvous server 101a are entities in a health information grid 102a.

Each entity includes a node and other items that are managed by the node. For example, the system administrator 170a includes a master node 172a that accesses the network 105 via signal line 167, an application server 132 for transmitting applications to the nodes and a provider directory 106 for storing information for accessing all the providers in the system 100b. A specialty physician 190a includes a node 162a that accesses the network 105 via signal line 177 and an electronic medical record (EMR) database 107a for storing patient information. A hospital 160 includes a node 162c and a hospital systems database 109 for storing information for running the hospital. A primary care physician 180 includes a node 162d for accessing the network 105 via signal line 193 and an EMR database 107b.

A node 162 typically operates on a local network behind a firewall 185 and supports agents 164 that enable integration, workflow, storage, management and communications from, for example, a local computer. The local computer directly accesses folders or other interfaces to a local network to use an application, and thus provides direct interoperability with other computers and networks from other nodes 162 and locales.

The nodes 162 are interconnected through the network 105 with the rendezvous server 101a. When messages are exchanged between nodes, the rendezvous server 101a typically receives data, such as encrypted healthcare data, from a node 162 and transmits the data to the gateway 185a, which transmits the data to the HISP server 103, which transmits the data to the recipients. If the recipients are other nodes 162 in the grid, the HISP server 103 directly transmits the data to the other node. For example, a primary care physician 180 transmits a message via the rendezvous server 101a to the gateway 185b, which transmits the message to the HISP server 103. The HISP server 103 determines whether the message is in the same domain and, if so, transmits the message directly to the hospital 160 via signal line 178.

Objects 166 are also typically provided at each node 162. Objects 166 can be used for storing and managing information at nodes 162. Objects 166 provide attributes and methods for creating, structuring, distributing and synchronizing information between multiple nodes 162. Objects 166 provide, for example, a unique object identifier and/or a list of nodes that participate in the object 166.

The following are examples of objects: credentials, certificates, names, phone numbers, identifiers, addresses, domains, users, email addresses, domains, specialties, specialty codes, provider relationships, contacts, language, language codes and providers. Objects include a topic and attributes. The credentials object includes the credential identifier (ID) topic and the following attributes: provider ID, type, name, number, description, date of issuance of the credentials, date of renewal of the credentials, issuing authority and date of expiration. The certificates object includes the certificate ID topic and the following attributes: provider ID, the type, the certificate and the description. The names object has a names ID topic and the following attributes: provider ID, the first name, the last name, the middle name, suffix and prefix. The phone numbers object includes a phone number ID topic and the following attributes: provider ID, the number type and the number. The identifiers object includes an identifier ID topic and the following attributes: provider ID, the issuer, the identifier, the status and the type. The addresses object includes an address ID topic and the following attributes: provider ID, the address type, the street, a second street option, the city, the state, the zip, the country, the latitude and the longitude. The domains object includes a domain ID topic and the following attributes: name, description and certificate. The specialties object include a specialties ID topic and the following attributes: specialty code ID rank. The specialty code object includes a specialty code ID topic and the following attributes: a HIPAA code and a description. The provider relationships object includes a provider relationships ID topic and the following attributes: primary provider ID and secondary provider ID. The contacts object includes a contact ID topic and the following attributes: provider ID, name of the provider, phone number for the provider and email address of the provider. The language object includes a language ID topic and the following attributes: provider ID and language code ID. The language codes object includes a language code topic and the following attributes: IDO6392 code and the English name of the language code. The email addresses object includes an email address ID topic and the following attributes: provider ID, address and Is Preferred. The users object includes a user ID topic and the following attributes: login, password, date of last login, date of creation, date of last update, provider ID and Is administrator. The providers object (e.g. information associated with a healthcare provider such as a doctor) receives a great deal of data from the other objects and includes a provider ID topic and the following attributes: provider type, type, status, gender, direct email address, electronic service uniform resource locator, date of creation, most recent update, date of birth, whether the provider is accepting new patients, a domain ID and whether the provider is verified.

At each node 162, agents 164 interface with local environments, extract data from a payload, parse the data, analyze the data, and/or transform the data into a desired format. Additionally, agents 164 create or modify objects 166 and securely distribute the object 166 to other nodes 162 via the rendezvous server 101a.

Agents 164 are software programs that are deployed to remote locations to interact with applications and/or users to perform workflow tasks, and to collaborate with other agents 164 across the health information grid 102a.

Nodes 162 provide an operating platform for agents 164 and instruct the agents 164 to store, distribute and manage information, such as healthcare information over the health information grid 102a. In one embodiment, each node 162 manages interactions between an agent 164 and databases, such as the provider directory 106, the hospital systems database 109 or the EMR database 107, for example. An agent 164c operating on node 162c at hospital 160 could receive healthcare data from the hospital systems database 109, process the healthcare data and forward the healthcare data from a hospital to a primary care physician 180 at node 162d and a specialty physician 190a at node 162a.

In one embodiment, a master node 172a includes a command agent 174a and an application server 132. The command agent 174a generates, deploys and activates agents 164 at various nodes 162. Multiple agents 164 may operate at a node 162 and multiple nodes 162 may operate at a particular local site. In the illustrated description, the system administrator 170a connects to master node 172a that provides command agent 174a for managing agents 164a, 164c and 164d. The application server 132 transmits applications and a provider directory from the provider directory database 106 to other entities including the non-grid sources 132 illustrated in FIG. 1a so that the non-grid sources 132 can install the application and become part of the system 100b.

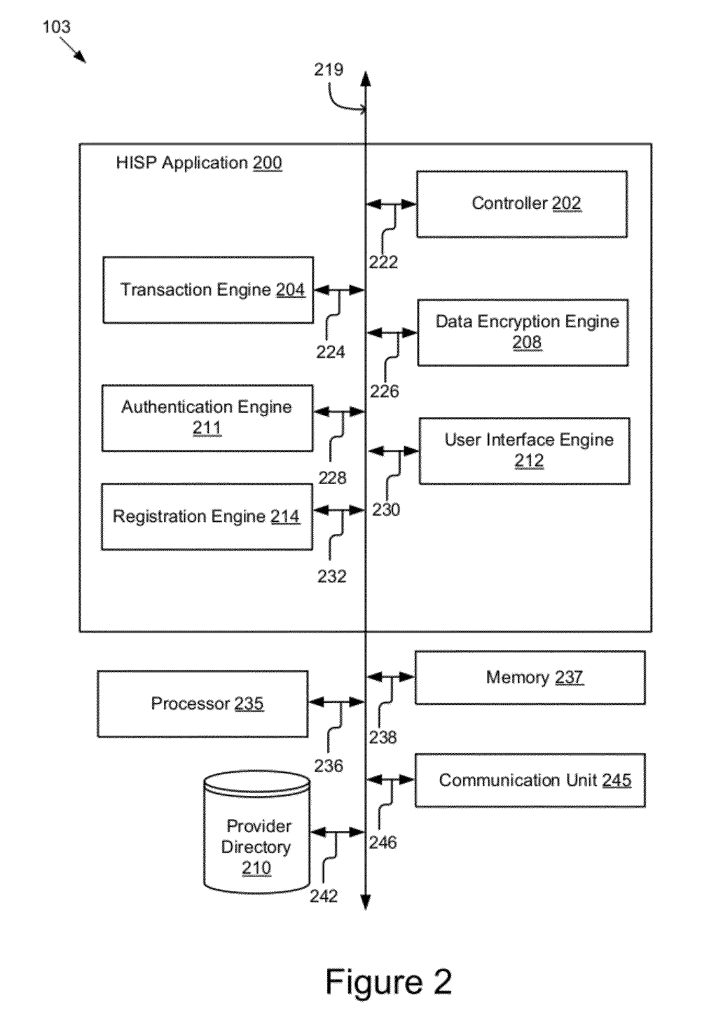

In one embodiment, the HISP server 103 is an Internet-based service that manages the secure exchange of information between nodes 162 and providers outside of the health information grid 102a. In one embodiment, the HISP server 103 exchanges messages using The DIRECT Project Specifications. In one embodiment, the HISP server 103 comprises a HISP application 200 for securely exchanging information between providers and a provider directory database 210 for storing contact information for the other users. The HISP application 200 is described in greater detail below with reference to FIG. 2.

### Example HISP Application 200

Referring now to FIG. 2, the HISP server 103 comprises a HISP application 200, a memory 237, a processor 235, a communication unit 245 and a provider directory database 210 that are each coupled to the bus 219. The bus 219 may represent one or more buses including an industry standard architecture (ISA) bus, a peripheral component interconnect (PCI) bus, a universal serial bus (USB), or some other bus known in the art to provide similar functionality. In one embodiment, the HISP application 200 comprises a controller 202, a transaction engine 204, a data translator 206, a data encryption engine 208, an authentication engine 211, a user interface engine 212 and a registration engine 214.

The processor 235 comprises an arithmetic logic unit, a microprocessor, a general purpose controller or some other processor array to perform computations and provide electronic display signals to a display device. The processor 235 is coupled to the bus 219 for communication with the other components via signal line 236. Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 237 stores instructions and/or data that may be executed by processor 235. The memory 237 is coupled to the bus 219 for communication with the other components via signal line 238. The instructions and/or data may comprise code for performing any and/or all of the techniques described herein. The memory 237 may be a dynamic random access memory (DRAM) device, a static random access memory (SRAM) device, flash memory or some other memory device known in the art. In one embodiment, the memory 237 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis.

The communication unit 245 transmits and receives data to and from nodes 162 and the rendezvous server 101. The communication unit 245 is coupled to the bus 219 via signal line 246. In one embodiment, the communication unit 245 includes a port for direct physical connection to the nodes 162, the rendezvous server 101 or to another communication channel. For example, the communication unit 245 includes a USB, SD, CAT-5 or similar port for wired communication with the rendezvous 101. In another embodiment, the communication unit 245 includes a wireless transceiver for exchanging data with the nodes 162, the rendezvous server 101 or any other communication channel using one or more wireless communication methods, such as IEEE 802.11, IEEE 802.16, BLUETOOTH® or another suitable wireless communication method.

In yet another embodiment, the communication unit 245 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the communication unit 245 includes a wired port and a wireless transceiver. The communication unit 245 also provides other conventional connections to the network for distribution of files and/or media objects using standard network protocols such as TCP/IP, HTTP, HTTPS and SMTP as will be understood to those skilled in the art.

The controller 202 is software including routines for managing the core functions of the HISP application 200 and for transmitting data to the different components. In one embodiment, the controller 202 is a set of instructions executable by the processor 235 to provide the functionality below for managing data. In another embodiment, the controller 202 is stored in the memory 237 and is accessible and executable by the processor 235. In either embodiment, the controller 202 is adapted for cooperation and communication with the processor 235 and other components of the HISP application 200 via signal line 222.

In one embodiment, the controller 202 performs core functions by listening for data by listening to ports, scanning folders, etc.; inserting data into locations such as a TCP port, folders, etc.; parsing by converting incoming data into objects, such as Java objects; analyzing by examining objects to determine actions; saving data by creating a provider directory entry or adding to a provider directory entry that is saved in the provider directory database 210; formatting by rendering data into the required format, such as by mapping, translating and grouping; sending packages of information for distribution and notifying by, for example, sending an email or a Web alert in response to an event occurring. In one embodiment, the controller 202 transmits requests for email addresses to the provider directory database 210 and transmits the results to a user device that transmitted the request via the communication unit 245.

The transaction engine 204 is software including routines for routing messages and requests for joining a health information grid 102. In one embodiment, the transaction engine 204 is a set of instructions executable by the processor 235 to provide the functionality below for exchanging information. In another embodiment, the transaction engine 204 is stored in the memory 237 and is accessible and executable by the processor 235. In either embodiment, the transaction engine 204 is adapted for cooperation and communication with the processor 235 and other components of the HISP application 200 via signal line 224.

The transaction engine 204 determines an endpoint for routing a message based on an entry in the provider directory database 210 that is associated with a destination of the message. The transaction engine 204 determines an encryption method for applying to the message based on capabilities of the endpoint. For example, the transaction engine 204 uses a standard email transport such as Simple Mail Transport Protocol (SMTP) and Secure MIME encryption (S/MIME) or XD*. In one embodiment, the transaction engine 204 instructs the user interface engine 212 to generate a user interface that displays information about transaction and message trends so that the system administrator can monitor the system and make decisions, such as whether to revoke a provider's access.

The data encryption engine 208 is software including routines for encrypting or decrypting messages. In one embodiment, the data encryption engine 208 is a set of instructions executable by the processor 235 to provide the functionality below for encrypting or decrypting messages. In another embodiment, the data encryption engine 208 is stored in the memory 237 and is accessible and executable by the processor 235. In either embodiment, the data encryption engine 208 is adapted for cooperation and communication with the processor 235 and other components of the HISP application 200 via signal line 226.

The data encryption engine 208 uses a public key infrastructure (PKI) for generating certificate and maintains both a white list of verified providers and a revocation list of users or entities that have had their public certificate withdrawn. In one embodiment, the data encryption engine 208 generates an x.509 certificate and associating the certificate with a user (i.e. an individual provider) or an entity, and manages public key certificates, certificate revocation lists, attribute certificates and a certification path validation algorithm. The data encryption engine 208 can expose the public certificate and the private key is held in a secure encrypted vault as well as a key store along with the public key. If the user or entity is deactivated at some future point, the data encryption engine 208 withdraws the public certificate and adds the user to a revocation list.

The authentication engine 211 is software including routines for verifying messages. In one embodiment, the authentication engine 211 is a set of instructions executable by the processor 235 to provide the functionality below for verifying messages. In another embodiment, the authentication engine 211 is stored in the memory 237 and is accessible and executable by the processor 235. In either embodiment, the authentication engine 211 is adapted for cooperation and communication with the processor 235 and other components of the HISP application 200 via signal line 228. The authentication engine 211 receives messages and verifies the message by, among other things, ensuring that the sender is part of the white list of other HISPs created by the data encryption engine 208.

The registration engine 214 is software including routines for registering providers. In one embodiment, the registration engine 214 is a set of instructions executable by the processor 235 to provide the functionality below for registering providers. In another embodiment, the registration engine 214 is stored in the memory 237 and is accessible and executable by the processor 235. In either embodiment, the registration engine 214 is adapted for cooperation and communication with the processor 235 and other components of the HISP application 200 via signal 232.

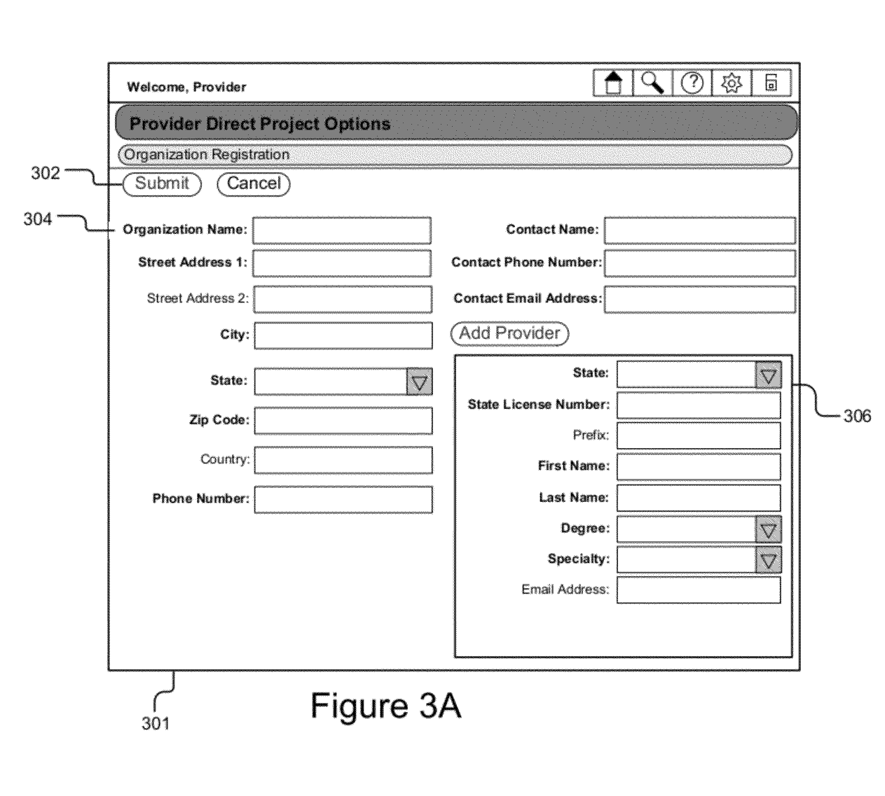

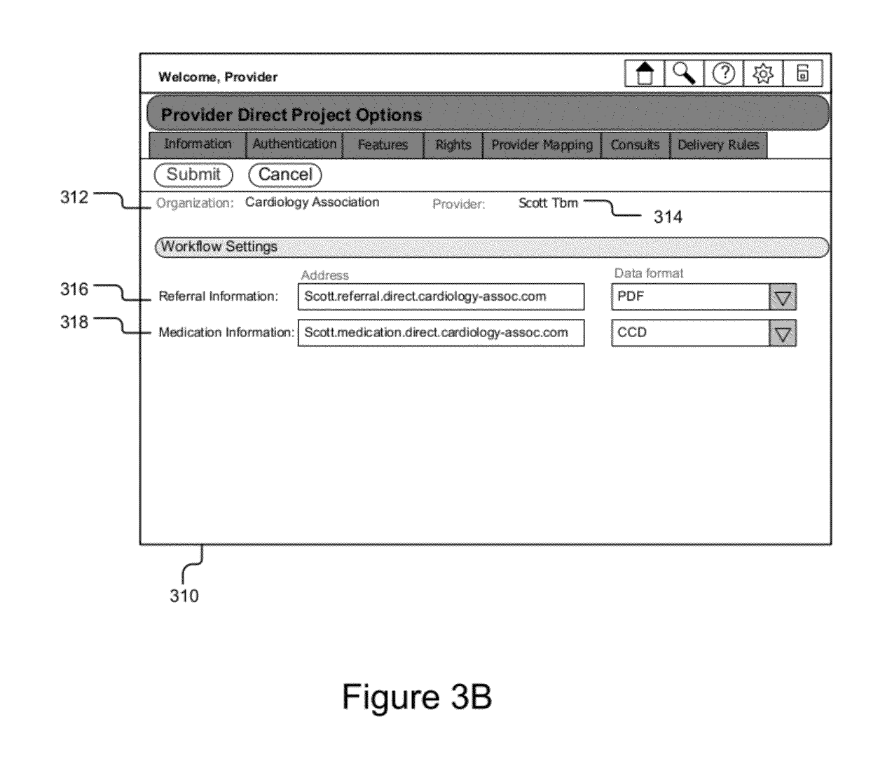

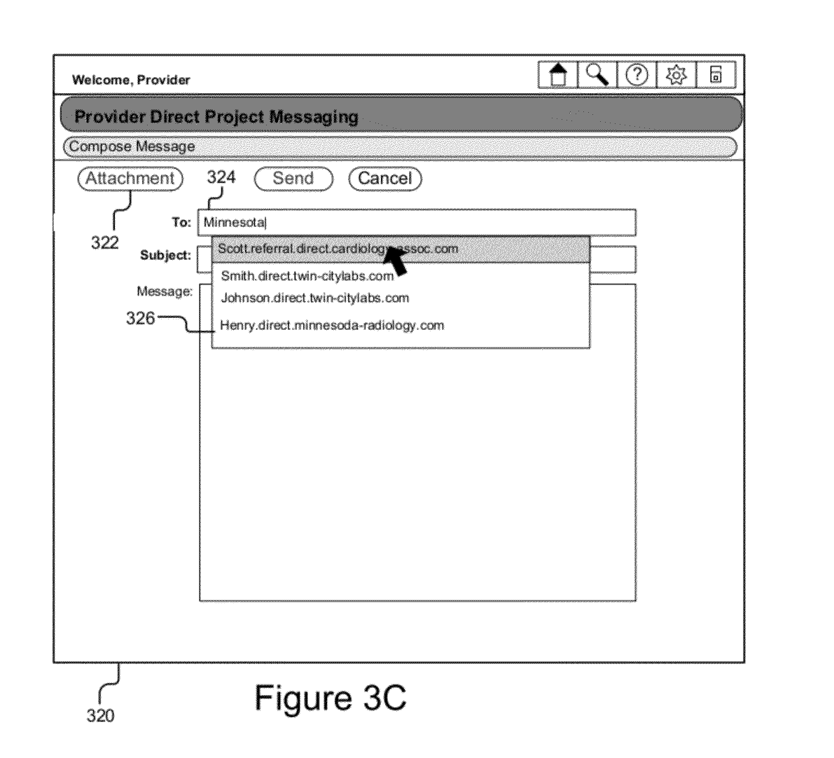

Registration begins when a user visits a website, prompts sign up by clicking a button and downloads an application from the application server 132 that includes software for installing a node. In another embodiment, the application only includes software for a registration wizard and the software for installing a node is not received until after registration and the user has been verified. The registration engine 214 instructs the user interface engine 212 to generate a user interface for receiving registration information. An example of a registration form is illustrated below in FIG. 3A. In one embodiment, the user interface is incorporated into a registration wizard that is part of the software downloaded by the user from the application server 132. In another embodiment, the user interface is transmitted to the user as a website that is completed before or after the software is selected for downloading. The user completes the user interface and the registration engine 214 receives the information for registering the user, such as the type of provider (e.g. general practice physician, oncologist, etc.), the provider's status, the provider's gender, a direct email address for the provider, the providers date of birth, a URL for the provider (e.g. Cardiology-Assoc.com), a domain name for branding the provider (e.g. CA) and whether the provider is accepting new patients.

The registration engine 214 instructs the user interface engine 212 to generate graphical data for displaying a request to a system administrator to verify the user and provide approval. The registration engine 214 receives the verification via the communication unit 245. In one embodiment, the registration engine 214 automatically verifies a provider based on information that may be known only to the provider, such as medical license number, birth date, etc. or may be manually verified using information attributes included in the provider directory but hidden from the general public or third-party sources. Verification of providers is important for establishing an overall trust relationship between the participants and the HISP.

The registration engine 214 then transmits the verification to the data encryption engine 208 so that the provider is added to the white list and the data encryption engine 208 generates a certificate for the provider. The registration engine 214 also sends notification to the application server 132 via the communication unit 245 that the user has permission to download another application for transmitting secure messages and a provider directory for contacting other HISPs.

The registration engine 214 also generates the provider directory and stores it in the provider directory database 210. The registration engine 214 assigns a URL to the provider that is domain branded based on information received during registration. For example, the registration engine 214 assigns Cardiology-Assoc.com the provider directory website URL: http://CA.medicity.net. In one embodiment, the registration engine 214 receives information from the user interface engine 212 for customizing the website for the provider. For example, the provider can upload an image of the CA logo that is automatically incorporated into the provider directory website by the user interface engine 212.

In addition to using the provider's URL for the provider directory website URL, the registration engine 214 uses the provider's URL for assigning email addresses for receiving direct messages from other users in the system. For example, the registration engine 214 assigns the user Scott Tbm different email addresses off of the email address Scott.function.direct.cardiology-assoc.com.

In addition to transmitting requests to the system administrator for verification, in one embodiment, the registration engine 214 instructs the user interface engine 212 to generate a user interface for including information that helps the system administrator monitor enrollment, create trusted relationships with other HISPs and instruct the data encryption engine 208 to deactivate existing users as needed.

### User Interface Engine 212

The user interface engine 212 is software including routines for generating a user interface in response to instructions received from the other components of the HISP application 200. In one embodiment, the user interface engine 212 is a set of instructions executable by the processor 235 to provide the functionality described below for generating a user interface for the registration engine 214 and other components of the HISP application 200. In another embodiment, the user interface engine 212 is stored in memory 237 of the rendezvous server 101 and is accessible and executable by the processor 235. In either embodiment, the user interface engine 212 is adapted for cooperation and communication with the processor 235, the provider directory 210 and other components of the rendezvous 101 via the signal line 230. The user interface engine 212 is described in further detail with reference to FIGS. 3-5.

FIG. 3A is a graphic representation of a user interface 301 that is generated by the user interface engine 212 for registering a provider to exchange healthcare information with other providers. The user interface 301 generates graphical data for displaying a form comprising fields 304 and 306 for entering organization and provider information to register the provider. The organization information includes name, address and contact information. The provider information includes the state and state license of the provider, name, education, specialty and email address. A user submits the registration information by pressing the submit button 302. Persons of ordinary skill in the art will recognize that other fields can also be displayed for registering a provider. The registration engine 214 receives the information and registers the provider.

FIG. 3B is a graphic representation of a user interface 310 that is generated by the user interface engine 212 for associating a provider with a health domain address. The user interface 310 generates graphical data for displaying inputs for associating a provider with one or more health domain addresses. The provider 314 is a specialist at organization 312. In one embodiment, the provider 314 receives messages at different addresses based on the type of information or workflow information. In the example, line 316 indicates that the provider 314 receives referral information at “Scott.referral.direct.cardiology-assoc.com.” Line 318 indicates that the provider 314 receives medication information for patients at “Scott.medication.direct.cardiology-assoc.com.” In another embodiment, a data format for the health information is specified. In the example, a referral is sent as a Portable Document Format (PDF) to the provider 314. Medication information is sent as a Continuity of Care Document (CCD). Persons of ordinary skill in the art will recognize that other formats of information can also be provided to the other provider including health level seven international (HL7).

FIG. 3C is a graphic representation of a user interface 320 that is generated by the user interface engine 212 for a provider to send a message to another user in the system. In one embodiment, the user selects a button or link for generating the email message and the user interface engine 212 generates graphical data for displaying the user interface of the email message. The user interface engine 212 transmits the graphical data to the user via the communication unit 245. The user can select the attachment button 322 for uploading an attachment, such as lab results for a patient.

The user enters information for sending the email address into the “to:” field 324 and the controller 202 transmits the request to the provider directory database 210. The provider directory database 210 executes a query for retrieving matching email addresses. For example, the provider inputs “Minnesota” into the “to:” field 324 and the provider directory database 210 queries for email addresses from other providers in Minnesota or email addresses that use Minnesota or a similar term in the email address. For example, the provider Scott in located in Minnesota, the Twin City Labs are located in Minnesota and the group Minnesoda Radiology in New Mexico is a close match because Minnesoda and Minnesota are only off by one character. The controller 202 transmits the results to the provide that requested the email addresses via the communication unit 245. The user interface engine 212 generates graphical data for displaying a drop down menu 326 with the results from the provider directory database 210.

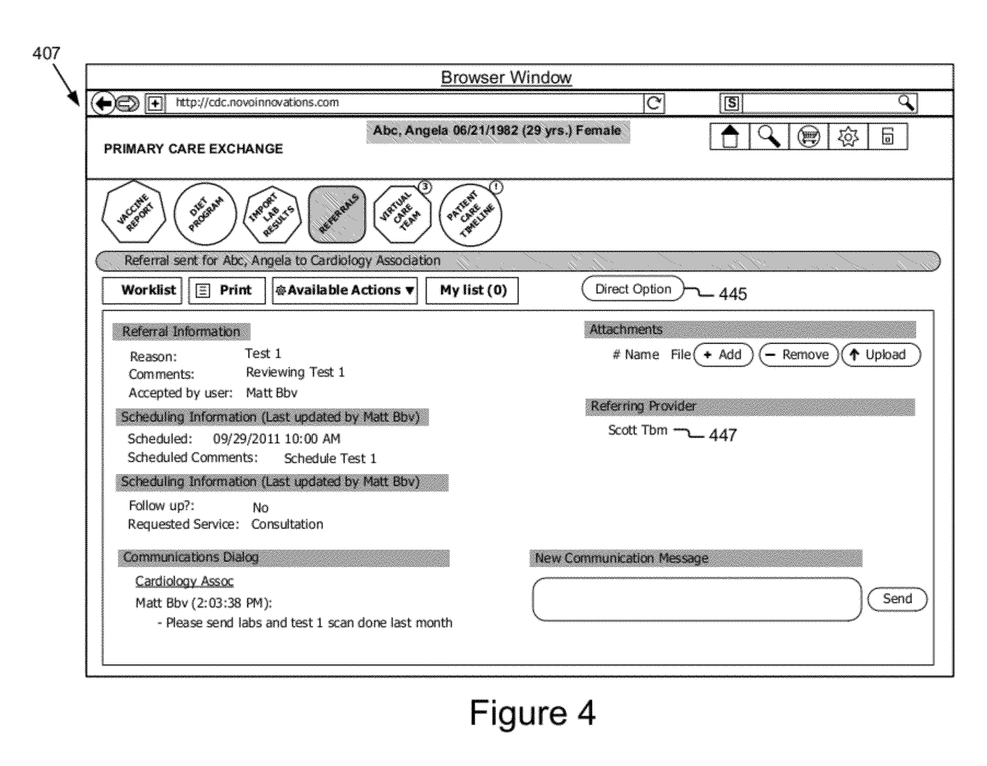

FIG. 4 is a graphic representation of an alternate user interface 407 for generating a message for secure transfer from one provider to another provider. The user interface 407 generates graphical data for displaying a referral by a primary care physician to a specialist, for example, a cardiologist. A user sends a referral to provider 447 by pressing button 445. In one embodiment, the referral information includes lab results, scheduling information or clinical data. In another embodiment, the referral information is embedded in a file attachment.

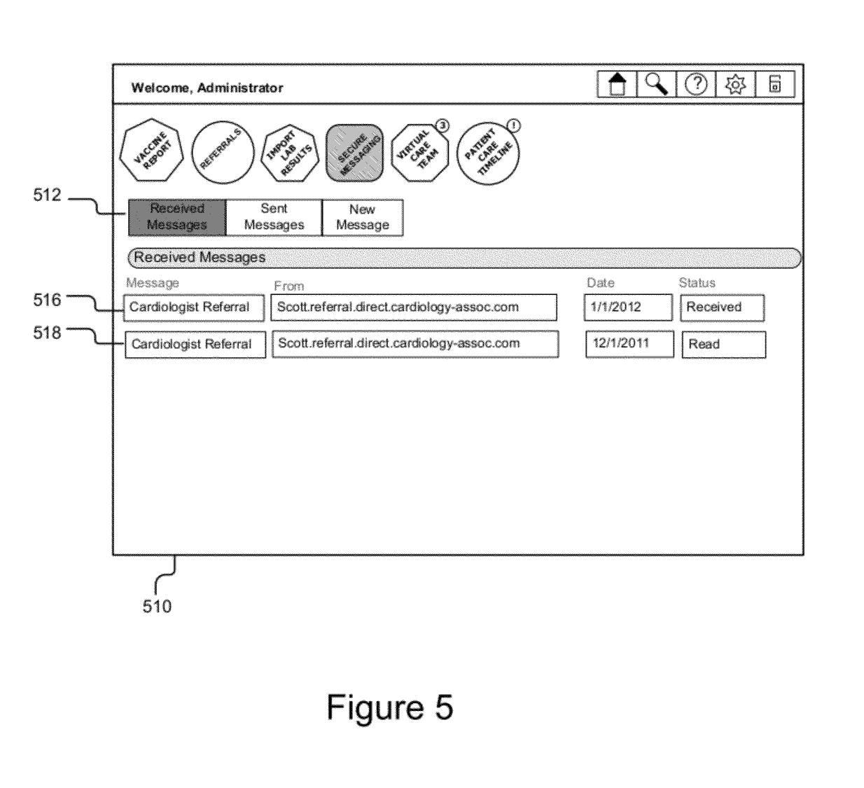

FIG. 5 is a graphic representation of a user interface 510 for viewing and sending messages. The user interface engine 212 generates graphical data for displaying a user interface that includes a menu button bar 512 with buttons for changing the view of the user interface 510. In this example, a user views received messages by selecting “Received Messages.” The received messages comprise messages 516 and 518 that include a type of the message, a sender of the message, data sent of the message and a status of the message.

### Methods

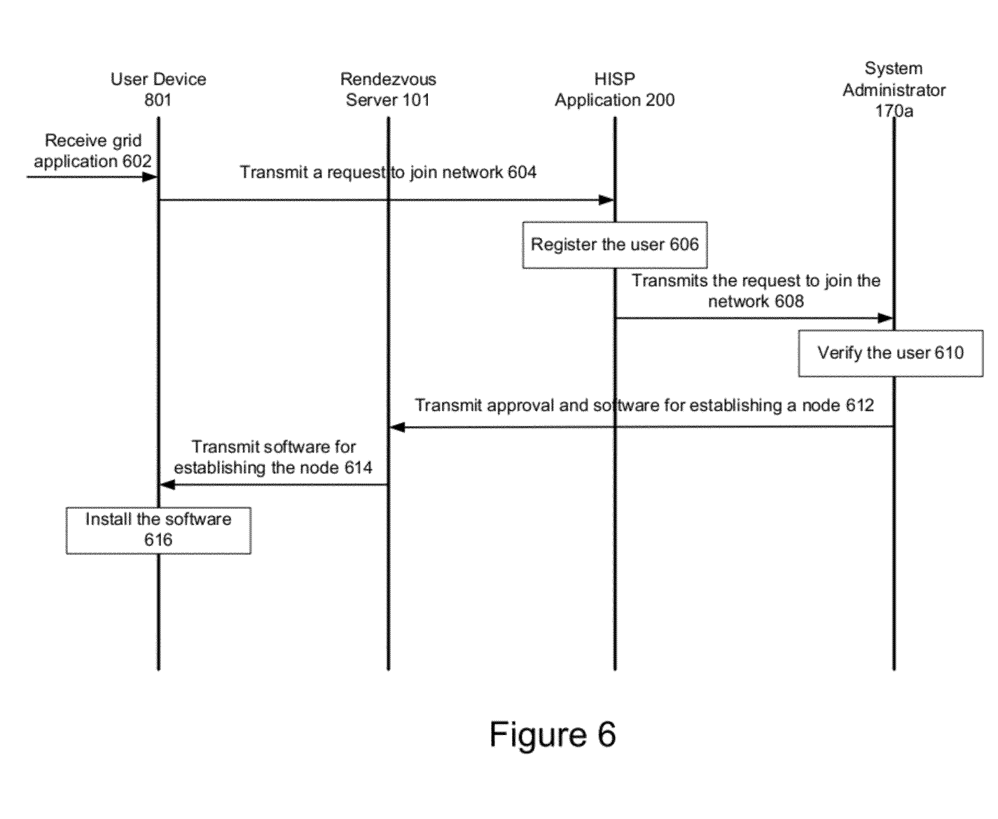

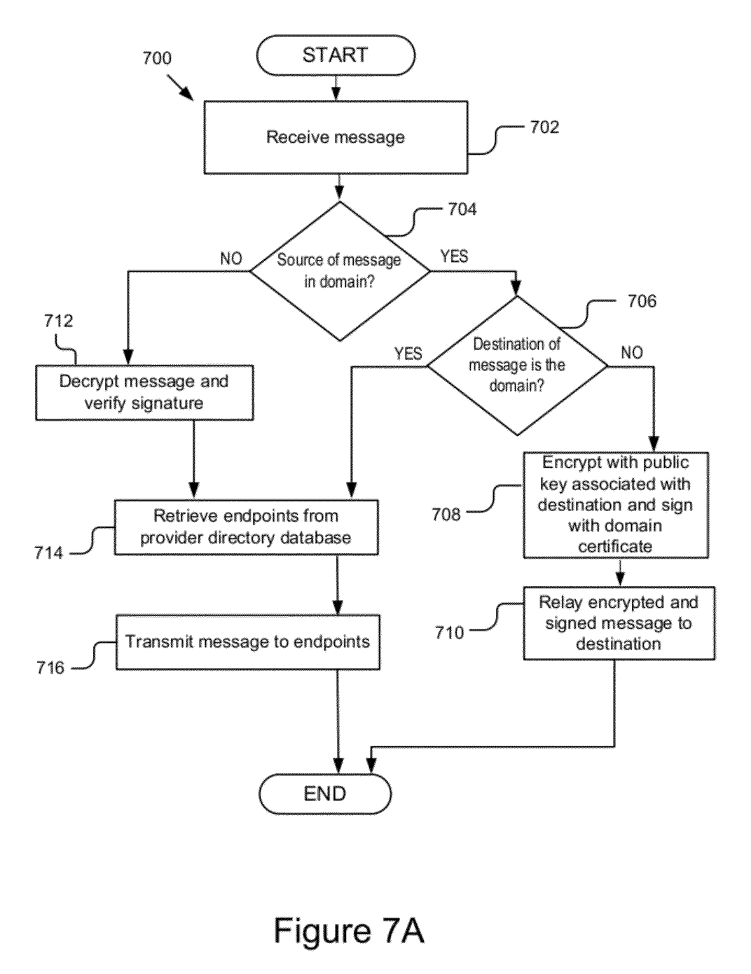

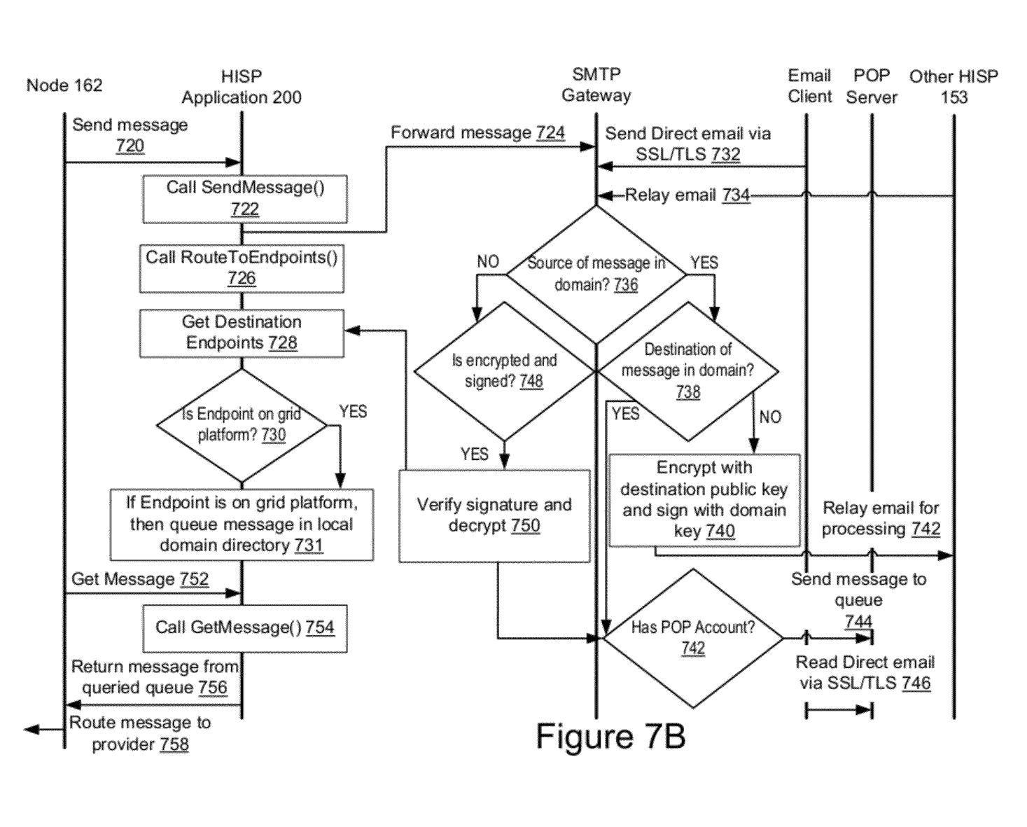

Referring now to FIGS. 6, 7A and 7B, various example embodiments of the invention will be described.

FIG. 6 is a flow diagram 600 illustrating one embodiment for enrolling a user and connecting the user to the grid. Persons of ordinary skill in the art will recognize that the user could be a hospital, a specialist, a provider, etc. In one embodiment, a user joins the system 100b illustrated in FIG. 1b by downloading an application from the application server 132 that includes instructions for accessing a specific node in the system 100.

The user device 801 receives 602 a grid application from the application server 132 that includes instructions for accessing the system administrator 170a. The user transmits 604 a request to the HISP application 200 to join the network 105. The registration engine 214 that is part of the HISP application 200 registers 606 the user and transmits 608 the request to join the network to the system administrator 170a. The system administrator 170a verifies 610 the user, for example, by confirming the user's medical license number and determining that the user is in good standing.

The system administrator 170a creates a node on a specific grid for the user and transmits 612 approval and software for establishing the node to the rendezvous server 101. In one embodiment, the system administrator 170a transmits the approval and software directly to the user device 801. The rendezvous server 101 transmits 614 the software for establishing the node to the user device 801. The user device 801 installs 616 the software for establishing the node. In one embodiment, the software includes a copy of the provider directory from the provider directory database 210. This contains all the information for directly contacting other users in the system 100. This is helpful in a variety of situations including requesting contact information from a HISP in a different state. In another embodiment, the software stored on the user device 801 requests the contact information from the HISP application 200. The user device 801 can notforward secure communications to the intended party by transmitting the communication to the rendezvous server 101, which forwards the application to the HISP application 200 as described in greater detail in FIGS. 7A and 7B. FIG. 7A is a flow diagram 700 illustrating one embodiment for securely exchanging healthcare information between providers. A HISP application 200 receives 602 a message. In one embodiment, the HISP application 200 is powered by Medicity®. The transaction engine 204 determines 704 whether a source of the message is a domain of the HISP application 200. For example, the domain of the HISP application 200 is medicity.net and the source of the message is provider1.medicity.net. If the source of the message is a domain of the HISP application 200, then the transaction engine 204 determines 706 whether a destination of the message is the domain of the HISP application 200. If the destination is not from the domain of the HISP application 200, for example the domain of the HISP application 200 is medicity.net and the destination is provider2.someHISP.net, the data encryption engine 208 encrypts 708 the message with a public key associated with the destination and signs the message with a domain certificate associated with the domain and/or the HISP. In one embodiment, the message is encrypted and signed with x.509 certificates. The transaction engine 204 relays 710 the encrypted and signed message to the destination. In one embodiment, the transaction engine 204 uses a standard email transport such as Simple Mail Transport Protocol (SMTP) and Secure MIME encryption (S/MIME). In another embodiment, the transaction engine 204 converts from the SMTP or S/MIME protocol to an integrating the healthcare enterprise (IHE) profile based protocol, such as XD*.

Referring back to step 706, if the transaction engine 204 determines that the destination is in the domain of the HISP application 200, then transaction engine 204 retrieves 714 one or more endpoints from a provider directory database 210 based on the destination. The transaction engine 204 transmits 716 the message to the endpoints. In one embodiment, an endpoint is a type of email client such as Outlook or Thunderbird and the communication unit 245 transmits the message to an email server such as a Post Office Protocol (POP) server or an Internet Message Access Protocol (IMAP) server for retrieval by the email client. If the endpoint is a platform that is a non-grid recipient 130, such as the one illustrated in FIG. 1a, the communication unit 245 establishes a transport layer security (TSL) connection between the HISP application 200 and the non-grid recipient 130. In another embodiment, the endpoint is an electronic medical record (EMR). In yet another embodiment, the endpoint is a secure messaging application and the message is transmitted to a mailbox of a grid participant that is associated with the destination for retrieval by the messaging application.

Referring back to step 704, if the transaction engine 204 determines that the source of the message is not in the domain of the HISP application 200, then the data encryption engine 208 decrypts 712 the message and the authentication engine 211 verifies the signature of the message. In one embodiment, the message is decrypted with a private key. In another embodiment, the signature is verified using a Certificate Authority (CA). The method 600 then moves to the step 714 that is discussed above.

FIG. 7B is a flow diagram of an alternate embodiment for securely exchanging healthcare information between providers. A node 162 sends 720 a message to the HISP application 200. The HISP application 200 calls 722 SendMessage( ). The HISP application 200 forwards 724 the message to an SMTP gateway. The HISP application 200 calls 726 RouteToEndpoints( ) and gets 728 destination endpoints. The HISP application 200 determines 730 whether the endpoint is on the grid platform. If yes, the HISP application 200 queues 731 the message in a local domain directory.

The SMTP gateway receives messages from the HISP application 200, an email client and other HISPs. An email client sends 732 the direct email via a protocol, such as the secure socket layer (SSL)/TLS to the SMTP gateway. Another HISP 153 relays 734 email to the SMTP gateway. The SMTP gateway determines 736 whether the source of the message is in the domain. If yes, the SMTP gateway determines 738 whether the destination of the message is in the domain. If not, the SMTP gateway encrypts 740 the destination public key and signs with the domain key. If yes, the SMTP gateway determines 742 whether the endpoint has a POP account. If yes, the SMTP gateway sends 744 the message to the queue at the POP server. The email client reads 746 the direct email via the SSL/TLS.

If the source of the message is not the domain, the SMTP gateway determines 736 whether the message is encrypted and signed. If yes, the SMTP gateway verifies 750 the signature and decrypts the message. The method then proceeds to step 728.

The HISP application 200 gets 752 the message and calls 754 GetMessage( ). The HISP application 200 returns 756 the message from the queried queue to the node 162. The node 162 routes 758 the message to the provider.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method of exchanging healthcare information, the method comprising:
receiving a message including the healthcare information at a health information services provider (HISP) application having a domain;
determining whether a source of the message is from the domain;
retrieving an endpoint for transmitting the message to the destination from a provider directory; and
transmitting the message to the endpoint.

2. The method of claim 1, further comprising:
determining whether the destination of the message is from the domain.

3. The method of claim 2, wherein transmitting the message to the endpoint comprises:
transmitting the message to a mailbox of the destination based on determining that the source and the destination are from the domain.

4. The method of claim 1, wherein transmitting the message to the endpoint comprises:
determining an encryption method to apply to the message based on a type of the endpoint; and
determining a protocol for transmitting the message to the endpoint based on the type of the endpoint.

5. The method of claim 4, wherein the protocol is one from the group of Transport Layer Security, Secure/Multipurpose Internet Mail Extensions and XD*.

6. The method of claim 1, further comprising:
decrypting the message based on determining that the source of the message is not from the domain.

7. The method of claim 1 further comprising:
prior to receiving the message, receiving a request from a user device to join a network;
registering the user;
transmitting software for establishing a node for the user device; and
associating the node with the HISP application.

8. The method of claim 7, further comprising transmitting the request to join the network to a system administrator and receiving approval and software for establishing a node from the system administrator before transmitting the software for establishing a node.

9. A system of exchanging healthcare information, the system comprising:
a processor; and
a health information services provider (HISP) application stored on a memory and executable by the processor, the HISP application having a domain, the HISP application for receiving a message including the healthcare information, for determining whether a source of the message is from the domain, for retrieving an endpoint for transmitting the message to a destination from a provider directory and for transmitting the message to the endpoint.

10. The system of claim 9, wherein the HISP application determines whether the destination of the message is from the domain.

11. The system of claim 10, wherein transmitting the message to the endpoint comprises transmitting the message to a mailbox of the destination based on determining that the source and the destination are from the domain.

12. The system of claim 9, wherein transmitting the message to the endpoint comprises:
determining an encryption method to apply to the message based on a type of the endpoint; and
determining a protocol for transmitting the message to the endpoint based on the type of the endpoint.

13. The system of claim 12, wherein the protocol is one from the group of Transport Layer Security, Secure/Multipurpose Internet Mail Extensions and XD*.

14. The system of claim 9, wherein the HISP application decrypts the message based on determining that the source of the message is not from the domain.

15. The system of claim 9, wherein the HISP application, prior to receiving the message, receives a request from a user device to join a network, registers the user, transmits software for establishing a node for the user device and associates the node with the HISP application.

16. The system of claim 15, wherein the HIPS application transmits the request to join the network to a system administrator and receives approval and software for establishing a node from the system administrator before transmitting the software for establishing a node

17. A computer program product comprising a computer useable medium including a non-transitory computer readable program, wherein the computer readable program when executed on a computer causes the computer to:
receive a message including healthcare information at a health information services provider (HISP) application having a domain;
determine whether a source of the message is from the domain;
retrieve an endpoint for transmitting the message to a destination from a provider directory; and
transmit the message to the endpoint.

18. The computer program product of claim 17, further comprising determining whether the destination of the message is from the domain.

19. The computer program product of claim 18, wherein transmitting the message to the endpoint comprises transmitting the message to a mailbox of the destination based on determining that the source and the destination are from the domain.

20. The computer program product of claim 17, wherein transmitting the message to the endpoint comprises:
determining an encryption method to apply to the message based on a type of the endpoint; and
determining a protocol for transmitting the message to the endpoint based on the type of the endpoint.

21. The computer program product of claim 20, wherein the protocol is one from the group of Transport Layer Security, Secure/Multipurpose Internet Mail Extensions and XD*.

22. The computer program product of claim 17, further comprising decrypting the message based on determining that the source of the message is not from the domain.

23. The computer program product of claim 17, further comprising:
prior to receiving the message, receiving a request from a user device to join a network;
registering the user;
transmitting software for establishing a node for the user device; and
associating the node with the HISP application.

24. The computer program product of claim 22, further comprising transmitting the request to join the network to a system administrator and receiving approval and software for establishing a node from the system administrator before transmitting the software for establishing a node.
